(19) United States
(12) Patent Application Publication
(10) Pub. No.: US 2002/0089455 A1
(43) Pub. Date: Jul. 11, 2002

(54) Antenna

(75) Inventors: Sami Mikkonen, Oulu (FI); Ari Kalliokoski, Oulu (FI); Pekka Vayrynen, Oulu (FI)

Correspondence Address: Ware, Fressola, Van Der Sluys, & Adolphson LLP, Bradford Green, Building Five, 755 Main Street, PO Box 224, Monroe, CT, 06468, US

(73) Assignee: Nokia Corporation

(21) Appl. No.: 09/993,051

(22) Filed: Nov. 27, 2001

(30) Foreign Application Priority Data
Nov. 27, 2000 (GB) 0028851.4

(51) Int. Cl. H01Q 1/24; H01Q 1/38

(52) U.S. Cl. 343/702; 343/700 MS

(57) ABSTRACT

There is disclosed an antenna, suitable for use in a mobile device such as a mobile station, having a non-planar radiator surface extending in three dimensions.

### FIELD OF THE INVENTION

The present invention relates to antennas, particularly reflective antennas, and particularly but not exclusively to such antennas for use in mobile devices such as mobile telephones.

### BACKGROUND TO THE INVENTION

An antenna is an essential part of the radio frequency (RF) system of a mobile station (MS) such as a mobile telephone. In certain applications it is desirable to provide antennas internally within the structure of the mobile device rather than externally mounted to it. Internal antennas require space inside a mobile station's physical structure. However providing the antenna within the mobile station rather than external to the station, creates a conflict with the general desirability to minimise the physical size of the mobile device itself. The general desirability to minimise the size of a mobile station may be limited by providing the antenna within the station.

In addition the size of an internal antenna, and hence the amount of space required within the mobile station, is dependent upon frequency band(s) used by the mobile device. If the amount of space available within the mobile station is limited, then it may not be possible to implement the device at certain frequencies without increasing the size of the device.

Current designs for internal antennas tend to require a relatively large amount of space, and therefore limit the physical design of mobile stations.

It is therefore an aim of the present invention to provide an antenna suitable for use in a mobile station which can be more efficiently accommodated within a mobile station.

### SUMMARY OF THE INVENTION

According to the present invention there is provided an antenna having a non-planar radiator surface. The radiator surface preferably extends in three dimensions. Thus advantageously the surface area of the radiator surface is increased without increasing the physical size of the antenna. Alternatively, the surface area of the radiator surface is maintained whilst decreasing the physical size of the antenna.

The antenna is preferably provided with a ground plane provided opposite the radiator surface. The ground plane may have a planar surface.

A dielectric is preferably provided on the radiator surface. The dielectric is preferably provided to increase the average electrical height of the antenna. Thus the bandwidth of the antenna is not degraded.

In accordance with a further aspect of the present invention there is provided a mobile station including an internal antenna having a non-planar radiator surface.

### BRIEF DESCRIPTION OF THE DRAWINGS

The invention will be best understood by way of example with reference to the accompanying drawings in which:

FIG. 1 illustrates a conventional PIFA antenna with a planar radiator surface;

FIG. 2 illustrates an improved antenna in accordance with an embodiment of the invention;

FIG. 3 illustrates a further preferred modification the antenna of FIG. 2;

FIG. 4 illustrates the construction of exemplary antenna arrangements used for measurement purposes; and

FIGS. 5 illustrates measurement results achieved using the arrangements of FIG. 4.

### DESCRIPTION OF PREFERRED EMBODIMENTS

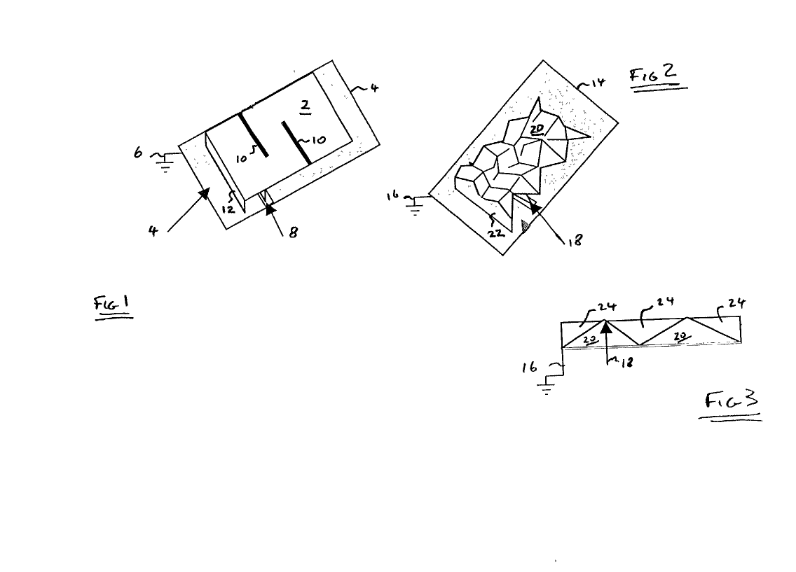

FIG. 1 illustrates an example of an existing planar inverted F-antenna (PIFA) used in current mobile station applications. As shown in FIG. 1, the radiator surface of the antenna comprises a planar surface 2. A ground plane 4, which may be a printed wiring board (PWB), is provided opposite the planar radiator surface 2, connected to a ground point 6. The radiator surface 2 is fed via a feeding point 8. As is also shown in FIG. 1, the radiator surface 2 is provided with two slots or cuts 10 in its surface which are provided, as is known, to adjust the performance of the antenna.

The planar radiating surface 2 is also shown having a perpendicular surface, 12, at its left hand side-. The surface 12 connects to the radiator surface to the ground plane.

In the known arrangement of FIG. 1, the size of the whole antenna arrangement is determined by the size of the planar radiator surface 2. In turn the size of the planar surface 2 is determined by the radio frequency at which the antenna is required to operate. For example, the size of the radiator surface for a device operating at the 400 MHz is twice the size of the radiator surface for a device operating at 900 MHz.

In an integrated antenna, as shown in FIG. 1, the radiation efficiency is dependent on antenna height and on the area of the radiator: as in an external antenna the length is the main parameter.

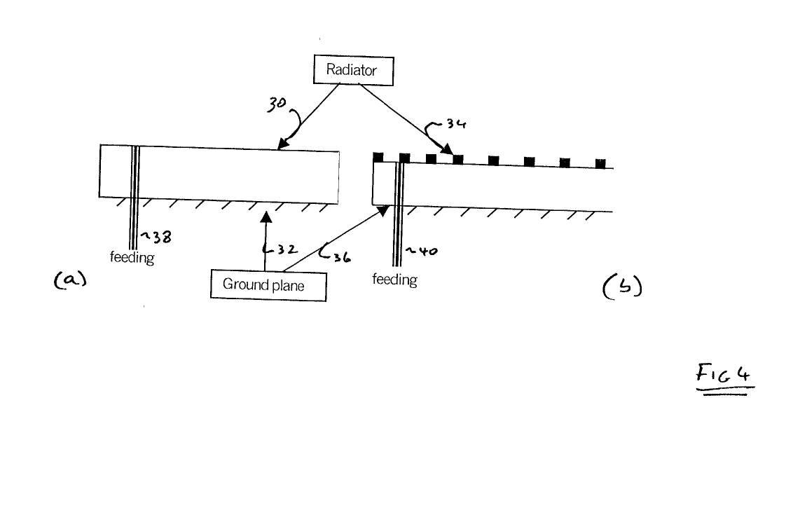

Referring now to FIG. 2 there is illustrated a modified antenna in accordance with an exemplary embodiment of the invention. A radiator surface 20 is again provided opposite a complimentary ground plane 14 connected to a ground point 16. The radiator surface 20 is fed via a feeding point 18. The radiator surface is connected to the ground plane via surface 22.

In accordance with the present invention, the radiator surface 20 is non-planar, having a three dimensional shape. Although in FIG. 2 it I shown that the radiator surface is shown to be covered with pyramid shapes. However the invention is not so limited, and other different shapes may form the radiator service.

By providing a non-planar surface, the actual surface area of the radiator surface is increased without increasing the height, length and width of the radiator surface. The radiator surface size is increased by introducing a fourth parameter: depth. The size of the radiator surface may then be varied by retaining a constant length and width and varying the depth or height.

The antenna shape can be created by bending of the radiator surface or by sputtering to a formed panel. Other techniques for forming the three dimensional radiator surface may be used.

The present invention allows the antenna to be made smaller by increasing the electrical length of the antenna by re-shaping the antenna radiator. In making the antenna smaller, less PWB area (ground plane) is required than a conventional PIFA.

In a PIFA lowering the antenna height (i.e. the distance between the planar radiator surface and the ground plane) typically narrows the bandwidth of the antenna and reducing the antenna area makes the gain smaller. In accordance with the invention the gain is increased for a given antenna size, and maintained whilst reducing the size of the antenna.

In the antenna according to the present invention the average electrical height of the antenna may be reduced due to the variation in the depth of the radiator surface. To avoid a detrimental effect on the antenna bandwidth, the height (i.e. the antenna's electrical height) is preferably maintained using a dielectric.

The non-planar radiator surface could be smoothed out with a dielectric such that the overall surface of the antenna system is planar. Referring to FIG. 3, a side-view of the antenna structure of FIG. 2 is illustrated, with the dielectric formed on the radiator surface. The dielectric 24 is shown formed in the ‘indentations’ provided by the nonplanar radiator surface.

The antenna surface of the inventive antenna is thus smoothed out with a dielectric substrate. The substrate may also be deposited in smaller amounts, such that the overall surface of the antenna is not planar. The extent of deposition of the substrate depends on system requirements, and the illustration of FIG. 3 is only an example.

The purpose of the dielectric substrate 24 on the radiator surface 20 is to maintain the effective electrical height of the antenna. This is preferable as the modification of the antenna in accordance with the invention to provide a non-planar radiator surface also effects the average height of the radiator surface above the ground plane. The average height of the radiator surface is in itself an important factor in the antenna performance, as it determines the effective electrical length of the antenna and thus the gain of the antenna. By introducing the dielectric 24, the average height of the antenna is increased and thus the electrical length, and hence the gain, of the antenna not compromised.

The dielectric material may be plastic, ceramic, or other suitable material.

In addition to adjusting the performance of the antenna by varying the depth of the nonplanar structure, slots or cuts may also be introduced into the radiator surface 20 to vary the antenna performance as in the prior art arrangement of FIG. 1.

Thus the invention may be advantageously used to:

a) reduce the size of the antenna whilst maintaining the radiator surface area and hence the RF performance; and

b) maintain the size of the antenna whilst increasing the radiator surface area and hence increasing the RF performance by providing a large improvement in the antennas bandwidth.

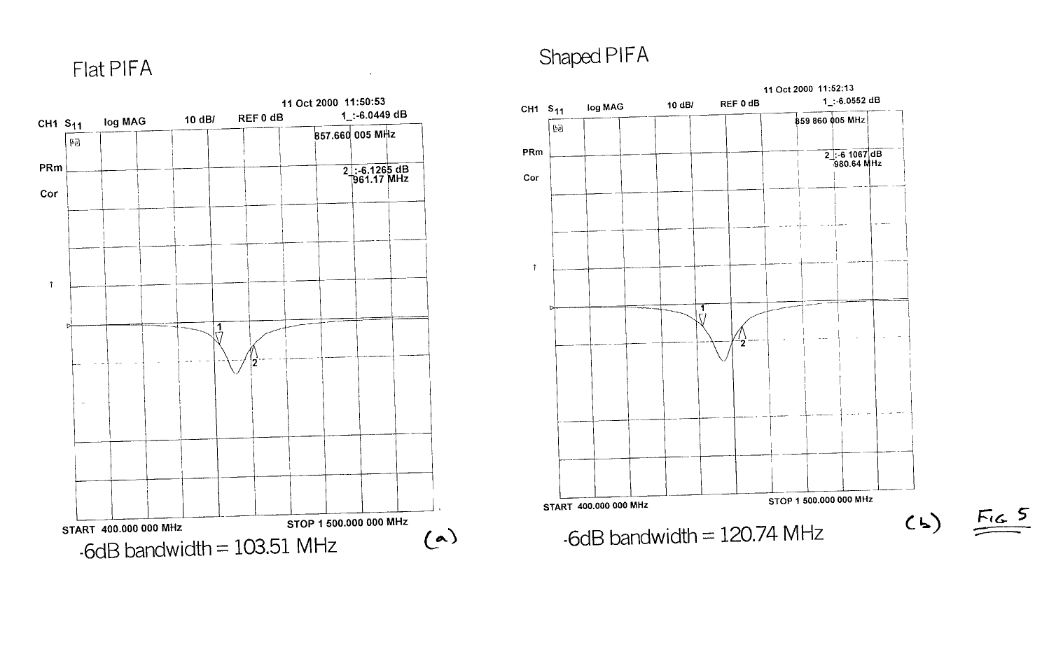

The advantage provided by (b) is particularly useful in relation to multi-band/multi-mode phones. An increase in bandwidth gives a good advantage with better performance. Measurements, which demonstrate the advantages achieved by the present invention will now be described. Referring to FIG. 4 the antenna configurations used to perform the simulations are illustrated. FIG. 4(a) illustrates a known PIFA antenna having a planar radiator surface 30 and a ground plane 32. FIG. 4(b) illustrates an antenna in accordance with an embodiment of the present invention, which may be termed a “shaped PIFA”, having a non-planar radiator surface 34 and a ground plane 36. Note for this simulation the inventive antenna is not provided with a dielectric. Each antenna has a respective antenna feed 38 and 40.

The impedance matching as measured for each antenna arrangement was measured, and the results are shown in FIG. 5.

The impedance matching, which represents the bandwidth performance, is illustrated for the prior art arrangement of FIG. 4(a) in FIG. 5(a) and for the inventive arrangement of FIG. 4(b) in FIG. 5(b). As can be seen there is a bandwidth improvement of 7 MHz for the antenna of the present invention.

It can thus be seen that the present invention uses the area and volume required by an antenna in a very efficient manner.

Internal antennas for GSM frequencies using prior art antennas require a relatively big size, for example in the region of 10% of the whole volume of a mobile station handset in some cases. Whilst the performance of the prior art antennas has been improved using cuts in the radiators planar surface, the invention shapes the radiator surface multidimensionally to more effectively improve antenna performance.

The present invention may be used in any application where a planar antenna, such as a PIFA, is used. It can be particularly advantageously applied in mobile telephone handsets. The application of the invention in mobile telephony is not limited to any particular standard such as GSM.

1. An antenna having a non-planar radiator surface.

2. An antenna according to claim 1 in which the radiator surface extends in three dimensions.

3. An antenna according to claim 1 or claim 2 further having a ground plane provided opposite the radiator surface.

4. An antenna according to claim 3 wherein the ground plane is a planar surface.

5. An antenna according to any preceding claim in which there is provided a dielectric on the radiator surface.

6. An antenna according to claim 5 wherein the dielectric increases the average height of the antenna.

7. A mobile station including an internal antenna having a non-planar radiator surface.
